(19) United States
(12) Patent Application Publication
(10) Pub. No.: US 2017/0126821 A1
(43) Pub. Date: May 4, 2017

(54) Analyzing the Online Behavior of a User and for Generating an Alert Based on Behavioral Deviations of the User

(71) Applicant: International Business Machines Corporation, Armonk, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata (IN)

(21) Appl. No.: 14/929,824

(22) Filed: Nov. 2, 2015

(51) Int. Cl. H04L 29/08; G08B 21/02; G08B 21/04

(52) U.S. Cl. CPC H04L 67/22; H04L 67/306; G08B 21/0423; G08B 21/0208

(57) ABSTRACT

A method in accordance with an embodiment includes: receiving data from at least one social media account of a user; generating a baseline personality profile of the user based on the received data, wherein the baseline personality profile establishes threshold values for a set of behavioral attributes of the user; iteratively generating a set of personality profiles of the user based on subsequently received data from the at least one social media account; comparing each personality profile of the user to the baseline personality profile of the user; determining a deviation between the personality profile of the user and the baseline personality profile of the user based on the comparing; and alerting a monitoring user of the deviation.

### TECHNICAL FIELD

The present invention relates generally to Internet interactions between multiple users, and more particularly, to analyzing the online behavior of a user and for generating an alert based on behavioral deviations of the user.

### RELATED ART

Internet users, including children, often have multiple online social media accounts. To this extent, Internet users are commonly exposed to a wide variety of information and interact with numerous other Internet users on a daily basis.

### SUMMARY

A first aspect of the invention provides a method, including: receiving data from at least one social media account of a user; generating a baseline personality profile of the user based on the received data, wherein the baseline personality profile establishes threshold values for a set of behavioral attributes of the user; iteratively generating a set of personality profiles of the user based on subsequently received data from the at least one social media account; comparing each personality profile of the user to the baseline personality profile of the user; determining a deviation between the personality profile of the user and the baseline personality profile of the user based on the comparing; and alerting a monitoring user of the deviation.

A second aspect of the invention provides an online monitoring system, including: a psycholinguistic profiling system for: receiving data from at least one social media account of a user; generating a baseline personality profile of the user based on the received data, wherein the baseline personality profile establishes threshold values for a set of behavioral attributes of the user; and iteratively generating a set of personality profiles of the user based on subsequently received data from the at least one social media account; a system for comparing each personality profile of the user to the baseline personality profile of the user; a system for determining a deviation between the personality profile of the user and the baseline personality profile of the user based on the comparing; and a system for alerting a monitoring user of the deviation.

A third aspect of the invention provides a computer program product comprising program code embodied in at least one computer-readable storage medium, which when executed, enables a computer system to implement a method, the method including: receiving data from at least one social media account of a user; generating a baseline personality profile of the user based on the received data, wherein the baseline personality profile establishes threshold values for a set of behavioral attributes of the user; iteratively generating a set of personality profiles of the user based on subsequently received data from the at least one social media account; comparing each personality profile of the user to the baseline personality profile of the user; determining a deviation between the personality profile of the user and the baseline personality profile of the user based on the comparing; and alerting a monitoring user of the deviation.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description taken in conjunction with the accompanying drawings that depict various aspects of the invention.

FIG. 1 depicts a behavior analysis system, according to embodiments.

FIG. 2 depicts an illustrative flow diagram of a process for analyzing the online behavior of a user and for generating an alert, according to embodiments.

FIG. 3 shows an illustrative computing environment, according to embodiments.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION

The present invention relates generally to Internet interactions between multiple users, and more particularly, to analyzing the online behavior of a user and for generating an alert based on behavioral deviations of the user.

According to embodiments, a baseline personality profile of a user is generated based on the online activity of the user on one more social media sites. The baseline personality profile of the user establishes a set of behavioral thresholds. The personality profile of the user is iteratively monitored over time and compared against the baseline personality profile to indicate behavioral changes both positive and negative relative to the set of behavioral thresholds. If the personality profile of the user deviates from the baseline personality profile, an alert may be generated.

Associates (e.g., “Friends” on Facebook) of the user on the social media sites are identified and interactions (and the frequency thereof) between the user and the associates of the user on the social media sites are monitored. The activity and behavior of the associates of the user on the social media sites are also monitored. Changes in the personality profile of the user may be correlated to the activity and behavior of one or more of the associates of the user, who may be identified in the generated alert.

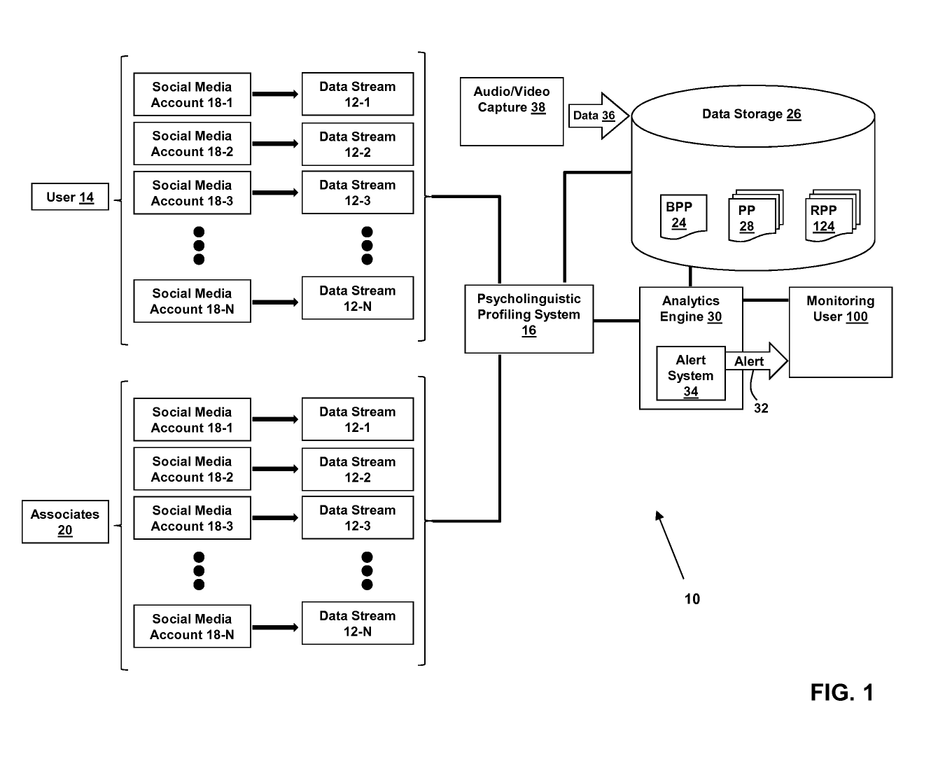

A behavior analysis system 10 according to embodiments is depicted in FIG. 1. A psycholinguistic profiling system 16 receives at least one data stream 12 of the social media activity of a user 14. N data streams 12 from N social media accounts 18 are shown in FIG. 1. The social media accounts 18 may include, for example, Facebook, Twitter, Google+, Vine, Tumblr, gaming chats, online chat rooms, email, instant messaging, etc. The social media activity of the user 14 may include, for example, data regarding what the user has read, posted, or shared on the social media accounts 18. One or more application programming interfaces (API), agents, and/or the like may be provided to integrate the behavior analysis system 10 with the social media accounts 18.

Any suitable psycholinguistic analysis system may be used to implement the functionality of the psycholinguistic profiling system 16 disclosed herein. For example, International Business Machines provides a set of data-analytics tools, called Life Event Detection and Psycholinguistic Analytics, that are capable of providing psycholinguistic profiling based on social media data.

The psycholinguistic profiling system 16 is configured to generate a baseline personality profile (BPP) 24 for the user 14, based on the online activity of the user 14 on the social media accounts 18 at a given time. The baseline personality profile 24 of the user 14, which may be stored in data storage 26, establishes threshold values for a set of behavioral attributes of the user 14. To generate the baseline personality profile 24, the psycholinguistic profiling system 16 may, for example, mine the online activity of the user for data (e.g., text, images (and associated metadata)) corresponding to each of the behavioral attributes in the set of behavioral attributes.

The psycholinguistic profiling system 16 iteratively monitors subsequent data streams 12 from the social media accounts 18 of the user 14 over time (e.g., periodically or continuously) to generate a temporal set of personality profiles (PP) 28 for the user 14. In embodiments, the personality profile 28 contains at least the same set of behavioral attributes included in the baseline personality profile 24. The set of personality profiles 28 may be stored in data storage 26.

An analytics engine 30 is provided for comparing each of the personality profiles 28 obtained for the user 14 with the baseline personality profile 24 obtained for the user 14. If the analytics engine 30 determines that a predetermined number (e.g., one or more) of the behavioral attributes in a given personality profile 28 deviate from a predetermined number (e.g., one or more) of corresponding behavioral attributes in the threshold set of behavioral attributes in the baseline personality profile 24, then an alert system 34 can provide an alert 32 (e.g., via text message, email, phone call, etc. to a monitoring user 100 (e.g., a parent in the case of a child, a supervisor in the case of an employee, etc.).

An audio/video capture system 38 may be used to capture audio and/or video data 36 of the user 14 and to store the captured audio and/or video data 36 in data storage 26. The audio/video capture system 38 may capture the audio and/or video data 36 in the car or home of the user 14, when the user 14 is interacting on a mobile device or computer, and/or the like. The psycholinguistic profiling system 16 may use the audio and/or video data 36 in the generation of the baseline personality profile (BPP) 24 and the set of personality profiles (PP) 28. The audio/video capture system 38 captures the audio and/or video data 36 over time to determine changes in, for example, the language, appearance, and behavior of the user 14.

The psycholinguistic profiling system 16 monitors the social media accounts 18 of the user 14 to determine, for example, interactions between the user 14 and associates 20 of the user 14, and the frequency of such interactions. The psycholinguistic profiling system 16, based on the monitoring, identifies the associates 20 of the user 14. After the psycholinguistic profiling system 16 has identified an associate 20, the psycholinguistic profiling system 16 monitors the social media activity of the associate 20. As shown in FIG. 1, for example, the psycholinguistic profiling system 16 may monitor at least one data stream 12 from at least one social media account 18 of the associate 20 of the user 14.

The psycholinguistic profiling system 16 generates a reference personality profile (RPP) 124 for each of the associates 20, based on the online activity of the associates 20 on the social media accounts 18. In embodiments, the reference personality profile 124 of each associate 20 contains at least the same set of behavioral attributes included in the baseline personality profile 24 of the user 14 and are generated by the psycholinguistic profiling system 16 in a similar manner. The reference personality profiles 124 may be stored in data storage 26. The psycholinguistic profiling system 16 may periodically generate an updated reference personality profile (RPP) 124 for each of the associates 20.

The analytics engine 30 may also be configured to analyze and monitor the audio and/or video data 36 of the user 14 captured by the audio/video capture system 38 and stored in data storage 26. This analysis may be used to determine changes in, for example, the language, appearance, and behavior of the user 14 over time. The analytics engine 30 may use, for example, natural language processing (NLP) to analyze text data (e.g., to detect specific keywords/phrases), speech recognition to analyze speech and audio data, and image analysis (e.g., image recognition) to analyze image and video data. For example, a user 14 may begin to include sensitive subject matter in posts made to a social media site. To this extent, the analytics engine 30 will detect the sensitive subject matter and send an alert 32 via the alert system 34 to a monitoring user 100. In this way, the monitoring user 100, having been notified regarding this behavioral change of the user 14, can take preemptive action. In another example, an associate 20 of the user 14 who has a criminal record and who the user 14 is not allowed to associate with may post an image showing the associate 20 and the user 14 together in a restaurant. Using image recognition, the analytics engine 30 will detect the associate 20 and user 14 together in the image and send an alert 32 via the alert system 34 to a monitoring user 100.

The monitoring user 100 may select the specific social media accounts 18 of the user 14 and associates 20 that should be monitored. Further, the monitoring user 100 may select specific content in each social media account 18 of the user 14 and associates 20 for monitoring. For example, if a user 14 exhibits a particular behavior, a monitoring user 100 may wish to monitor the social media accounts 18 of the user 14, as well as the social media accounts 18 of associates 20 of the user, for content and activities that may indicate or trigger the behavior. The monitoring user 100 may also select the threshold set of behavioral attributes of the user 14 included in the user's baseline personality profile 24.

In embodiments, the analytics engine 30 can compare the most recently obtained reference personality profile 124 of each associate 20 of the user 14 with the baseline personality profile 24 obtained for the user 14. If the analytics engine 30 determines that a predetermined number (e.g., one or more) of the behavioral attributes in a given reference personality profile 124 deviate from a predetermined number (e.g., one or more) of corresponding behavioral attributes in the threshold set of behavioral attributes in the baseline personality profile 24, the alert system 34 can provide an alert 32 to the monitoring user 100. Such an alert 32 may, for example, preemptively inform the monitoring user 100 that the associate 20 with the given reference personality profile 124 may be a bad influence on the user 14.

The analytics engine 30 is configured to determine changes in the behavior of the user 14 over time, for example, based on changes in the personality profiles 28 of the user 14 relative to the baseline personality profile 24 of the user 14 (and in some cases in response to changes over time in the captured audio and/or video data 36 of the user 14). In response to the analytics engine 30 detecting such behavioral changes, the alert system 34 may send an alert 32 to the monitoring user 100.

The alert 32 may include information regarding which of the associates 20 of the user 14, if any, may be at least partially responsible for the behavioral changes in the user 14. For example, the analytics engine 30 may correlate the behavioral changes of the user 14 (as indicated in one or more recent personality profiles 28 of the user 14) to the behavioral attributes of one or more of the associates 20 of the user 14. This may be accomplished, for example, by examining the reference personality profiles 124 of the associates 20 of the user 14 for behavioral attributes that may be related to the behavioral changes of the user 14. For example, if the user 14 starts to exhibit a particular behavior, then any associates 20 whose reference personality profiles 124 indicate the same behavior may be identified to the monitoring user 100. The monitoring user 100 may use this information as they see fit, for example, by preventing the user 14 from associating with the offending associates 20 in the future.

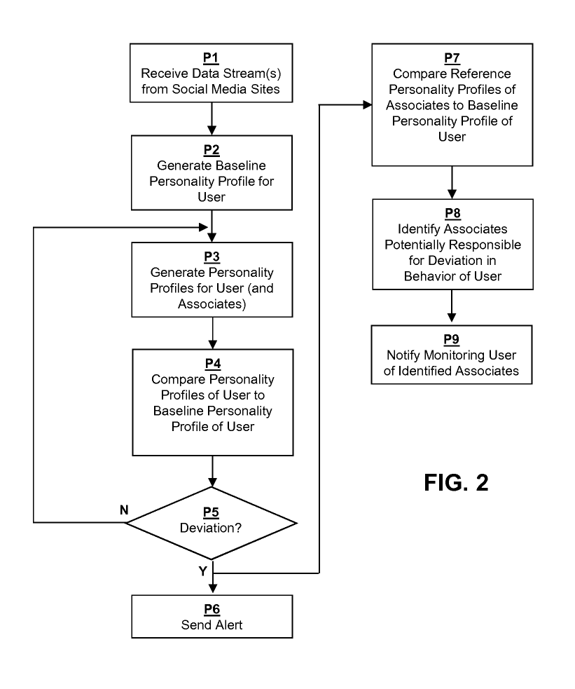

A flow diagram of a process for analyzing the online behavior of a user and for generating an alert, according to embodiments, is provided in FIG. 2.

At process P1, the psycholinguistic profiling system 16 receives at least one data stream 12 of the social media activity of a user 14 from at least one social media account 18. The psycholinguistic profiling system 16 may also receive at least one data stream 12 of the social media activity of at least one associate 20 of the user 14.

At process P2, the psycholinguistic profiling system 16 generates a baseline personality profile 24 for the user 14. To generate the baseline personality profile 24, the psycholinguistic profiling system 16 may, for example, mine the online activity of the user for data (e.g., text, images (and associated metadata)) corresponding to each of the behavioral attributes in the set of behavioral attributes.

At process P3, the psycholinguistic profiling system 16 generates a set of personality profiles 28 for the user 14 over time. The psycholinguistic profiling system 16 may also generate reference personality profiles 124 for each associate 20 of the user 14.

At process P4, the analytics engine 30 compares the personality profiles 28 of the user to the baseline personality profile 24 of the user 14.

At process P5, if the analytics engine 30 determines that there is a deviation away from the baseline personality profile 24 of the user 14 (YES, P5), the alert system 34 sends an alert to a monitoring user 100 at process P6. If the analytics engine 30 determines that there is no (or an insignificant) deviation (NO, P5), flow passes back to P3.

At process P5, if the analytics engine 30 determines that there is a deviation away from the baseline personality profile 24 of the user 14 (YES, P5), flow may also pass to process P7. At process P7, the analytics engine 30 compares the reference personality profile 124 of each associate 20 of the user 14 with the baseline personality profile 24 obtained for the user 14 in order to identify at process P8 associates 20 of the user 14 that may be responsible for the deviation in the behavior of the user 14. At process P9, the alert system 34 alerts the monitoring user 100 of the identified associates 20.

According to embodiments, the behavior of the monitoring user 100 (e.g., a parent) may actually be responsible for deviations in the behavior of the user 14 (e.g., a child). In such a case, the alert system 34 can notify the monitoring user 100 that their bad behavior around the user 14 is not suitable. The bad behavior can include, for example, the use of bad language, bad gestures, bad etiquette, quarreling, etc. In addition to notifying the monitoring user 100 that their behavior is subpar, the user 14 may be distracted from such behavior by, for example, automatically playing music, turning on the TV, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the program product of the present invention may be manually loaded directly in a computer system via a storage medium such as a CD, DVD, etc., the program product may also be automatically or semi-automatically deployed into a computer system by sending the program product to a central server or a group of central servers. The program product may then be downloaded into client computers that will execute the program product. Alternatively the program product may be sent directly to a client system via e-mail. The program product may then either be detached to a directory or loaded into a directory by a button on the e-mail that executes a program that detaches the program product into a directory. Another alternative is to send the program product directly to a directory on a client computer hard drive.

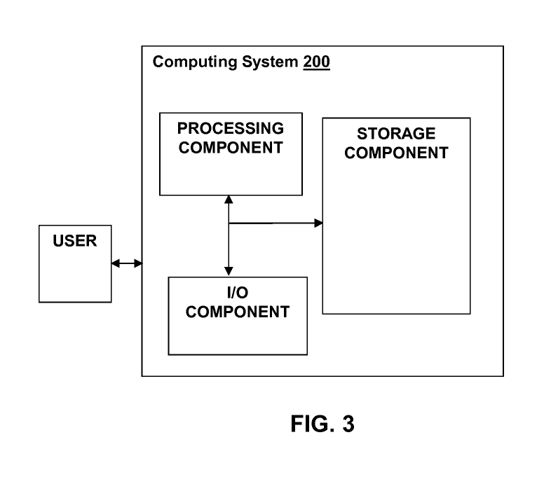

FIG. 3 depicts an illustrative computing system 200 for implementing the present invention, according to embodiments. The computing system 200 may comprise any type of computing device and, and for example includes at least one processor, memory, an input/output (I/O) (e.g., one or more I/O interfaces and/or devices), and a communications pathway. In general, processor(s) execute program code, such as behavior analysis system 10, which is at least partially fixed in memory. While executing program code, processor(s) can process data, which can result in reading and/or writing transformed data from/to memory and/or I/O for further processing. The pathway provides a communications link between each of the components in computing system 200. I/O can comprise one or more human I/O devices, which enable a user to interact with computing system 200.

Technical effects of the systems and methods disclosed herein include balancing network bandwidth by predicting network bandwidth requirements for each of a plurality of geographical regions based on an analysis of weather data and the social media sentiment. The embodiments discussed herein can allow hardware, software, and/or combinations thereof to automatically balance network bandwidth without intervention from a human user. In addition, the embodiments discussed herein can ensure that a VPN has adequate bandwidth to serve all users in all geographical regions during a given time period.

The various embodiments discussed herein can offer several technical and commercial advantages, some of which are discussed herein by way of example. Embodiments of the present disclosure can eliminate the deficiencies suffered by the reactive network bandwidth balancing techniques employed by the prior art. Furthermore, embodiments of the method discussed herein can be used to automatically balance network bandwidth to minimize the over/under subscribing of network resources.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual skilled in the art are included within the scope of the invention as defined by the accompanying claims.

What is claimed is:

1. A method, comprising:
receiving data from at least one social media account of a user;
generating a baseline personality profile of the user based on the received data, wherein the baseline personality profile establishes threshold values for a set of behavioral attributes of the user;
iteratively generating a set of personality profiles of the user based on subsequently received data from the at least one social media account;
comparing each personality profile of the user to the baseline personality profile of the user;
determining a deviation between the personality profile of the user and the baseline personality profile of the user based on the comparing; and
alerting a monitoring user of the deviation.

2. The method of claim 1, further comprising identifying at least one associate of the user on the at least one social media account.

3. The method of claim 2, further comprising:
obtaining data for each identified associate from the at least one social media account; and
generating a reference personality profile for each associate based on the obtained data.

4. The method of claim 3, further comprising determining interactions and frequency of interactions between each associate and the user on the at least one social media account.

5. The method of claim 3, further comprising comparing the reference personality profile of each associate to the baseline personality profile of the user to identify a source of the deviation.

6. The method of claim 5, further comprising notifying the monitoring user of the identified source of the deviation.

7. The method of claim 1, further comprising:
capturing at least one of audio data and video data of the user;
identifying deviations in behavior of the user based on the captured data; and
alerting the monitoring user of the identified deviation in behavior of the user.

8. An online monitoring system, comprising:
a psycholinguistic profiling system for:
receiving data from at least one social media account of a user;
generating a baseline personality profile of the user based on the received data, wherein the baseline personality profile establishes threshold values for a set of behavioral attributes of the user; and
iteratively generating a set of personality profiles of the user based on subsequently received data from the at least one social media account;
a system for comparing each personality profile of the user to the baseline personality profile of the user;
a system for determining a deviation between the personality profile of the user and the baseline personality profile of the user based on the comparing; and
a system for alerting a monitoring user of the deviation.

9. The online monitoring system of claim 8, wherein the psycholinguistic profiling system identifies at least one associate of the user on the at least one social media account.

10. The online monitoring system of claim 9, wherein the psycholinguistic profiling system:
obtains data for the at least one associate from the at least one social media account; and
generates a reference personality profile for each associate based on the obtained data.

11. The online monitoring system of claim 10, wherein the system for comparing compares the reference personality profile of each associate to the baseline personality profile of the user to identify a source of the deviation.

12. The online monitoring system of claim 11, and wherein the system for alerting notifies the monitoring user of the identified source of the deviation.

13. The online monitoring system of claim 8, further comprising a system for capturing audio data and/or video data of the user, wherein the system for comparing identifies deviations in behavior of the user based on the captured data, and wherein the system for alerting alerts the monitoring user of the identified deviation in behavior of the user.

14. A computer program product comprising program code embodied in at least one computer-readable storage medium, which when executed, enables a computer system to implement a method, the method comprising:
receiving data from at least one social media account of a user;
generating a baseline personality profile of the user based on the received data, wherein the baseline personality profile establishes threshold values for a set of behavioral attributes of the user;
iteratively generating a set of personality profiles of the user based on subsequently received data from the at least one social media account;
comparing each personality profile of the user to the baseline personality profile of the user;
determining a deviation between the personality profile of the user and the baseline personality profile of the user based on the comparing; and
alerting a monitoring user of the deviation.

15. The computer program product of claim 14, the method further comprising identifying at least one associate of the user on the at least one social media account.

16. The computer program product of claim 15, the method further comprising:
obtaining data for each identified associate from the at least one social media account; and
generating a reference personality profile for each associate based on the obtained data.

17. The computer program product of claim 16, the method further comprising determining interactions and frequency of interactions between each associate and the user on the at least one social media account.

18. The computer program product of claim 16, the method further comprising comparing the reference personality profile of each associate to the baseline personality profile of the user to identify a source of the deviation.

19. The computer program product of claim 18, the method further comprising notifying the monitoring user of the identified source of the deviation.

20. The computer program product of claim 14, the method further comprising:
capturing audio data and/or video data of the user;
identifying deviations in behavior of the user based on the captured data; and
alerting the monitoring user of the identified deviation in behavior of the user.
